(19) United States
(12) Patent Application Publication
(10) Pub. No.: US 2012/0296970 A1
(43) Pub. Date: Nov. 22, 2012

(54) FILE MANAGING APPARATUS FOR MANAGING ACCESS TO AN ONLINE STORAGE SERVICE

(75) Inventor: Satoru GOTO, Nagoya-shi (JP)

(73) Assignee: Buffalo Inc., Nagoya-shi (JP)

(21) Appl. No.: 13/475,406

(22) Filed: May 18, 2012

(30) Foreign Application Priority Data
May 19, 2011 (JP) 2011-112924

(51) Int. Cl. G06F 12/08; G06F 15/16

(52) U.S. Cl. 709/204; 711/133; 709/217; 711/E12.017

(57) ABSTRACT

A file managing apparatus that caches a file to be uploaded to an online storage; and controls withholding uploading the file to the online storage until a predetermined withholding time elapses since the file has been cached, even if the file is updated.

### CROSS REFERENCE TO RELATED APPLICATIONS

The present application claims priority to Japanese Patent Application No. 2011-112924 filed on May 19, 2011, the disclosure of which is hereby incorporated by reference in its entirety.

### BACKGROUND OF THE DISCLOSURE

1. Field of the Disclosure

The present disclosure relates to a file managing apparatus capable of being used with an online storage service and a non-transitory computer readable storage medium storing a control program executed by the file managing apparatus.

2. Description of the Related Art

Conventionally, in order to store various types of files, a local storage such as a storage device provided in a terminal apparatus of a user (hereafter referred to as “user terminal”), a storage device connected to the user terminal and the like is used.

In the recent years, an online service (web service) that can store files in an online storage provided on the Internet is being offered accompanying a development of communication technology. In such a service, the user terminal performs uploads and downloads of files to and from the online storage.

Further, to improve convenience of the online storage, a file managing apparatus that offers a use experience that does not give a sense of presence of the online storage despite the fact of actually using the online storage is being proposed (see Japanese Patent Application Laid-Open Publication No. 2010-287104).

The file managing apparatus described in Japanese Patent Application Laid-Open No. 2010-287104 includes an application for automatically uploading to an online storage files that were stored or updated to the apparatus itself. A virtual file is displayed to the user for feigning as if the files in the online storage are within the apparatus itself.

The file managing apparatus described in Japanese Patent Application Laid-Open No. 2010-287104 is configured to upload a file to the online storage each time the file is stored or updated to the file managing apparatus itself.

However, in configuring as above, in dealing with a frequently updated file, there is a problem that a traffic load for uploading increases due to the upload from the file managing apparatus to the online storage becomes frequent.

Therefore, the present disclosure aims to provide a file managing apparatus that can prevent the increase in the traffic load even in dealing with the frequently updated file.

### SUMMARY OF THE INVENTION

The present disclosure is directed to a file managing apparatus that caches a file to be uploaded to an online storage; and controls withholding uploading the file to the online storage until a predetermined withholding time elapses since the file has been cached, even if the file is updated.

### BRIEF DESCRIPTION OF THE DRAWINGS

FIG. 1 is an overall configuration drawing of a communication system according to the present disclosure;

FIG. 2 is a hardware configuration diagram of a NAS according to the present disclosure;

FIG. 3 is a software configuration diagram of the NAS according to the present disclosure;

FIG. 4 is a diagram showing a specific example of a directory configuration that a file managing section manages;

FIG. 5 is an operational flow chart of the NAS according to the present disclosure; and

FIG. 6 is a flow chart of an upload process in step S300 of FIG. 5; and

FIG. 7 is a flow chart of a download process in step S300 of FIG. 5.

### DETAILED DESCRIPTION OF EMBODIMENTS

The present disclosure will be explained with reference to the drawings. The present disclosure adapts a NAS (Network Attached Storage), for example, as the file managing apparatus. In the drawings of the embodiment hereafter, identical or similar reference signs are given to identical or similar components.

(System Configuration)

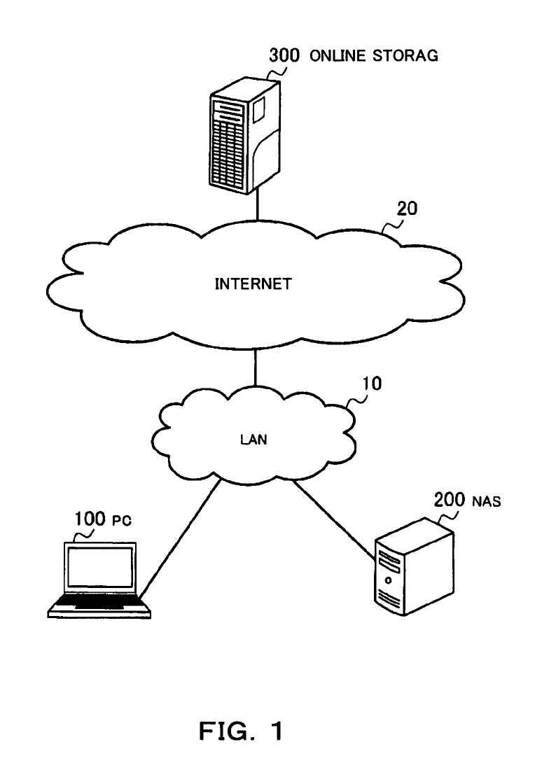

First, an overall configuration of the communication system according to the present disclosure will be explained. FIG. 1 is an overall configuration drawing of a communication system 1 according to the present disclosure.

As shown in FIG. 1, the communication system 1 includes a PC 100, a NAS 200 and an online storage 300. The PC 100 corresponds to a user terminal. Alternatively, instead of the PC 100, a cell phone terminal, a network compatible television receiver and the like may be adapted as the user terminal.

The PC 100 and the NAS 200 are connected to a LAN (Local Area Network) 10 such as an in-house network and are capable of communicating with one another through the LAN 10. The LAN 10 is connected to the Internet 20 through a router and the like. The online storage 300 is connected to the Internet 20.

The PC 100 is an information processing apparatus that is operated by a user, and is furnished with a network communicating function for performing network communication and a user I/F (display, keyboard, mouse and the like). The PC 100 stores and reads files to and from the NAS 200 through the LAN 10.

The NAS 200 is a file server specialized in file storage and management, and is furnished with a file system for performing the file management and the network communicating function for performing the network communication. The NAS 200 may be shared by a plurality of user terminals.

The online storage 300 provides a web service capable of storing files, and is configured of one or more file servers. For example, the online storage 300 provides a storage area which the user can utilize by the user of the PC 100 registering to the web server. In the present disclosure, it is assumed that the user of the PC 100 has already registered to the service provided by the online storage 300.

Further, a utilization restriction is set to the online storage 300 by a service provider. In the present disclosure, the utilization restriction means that an upper limit value is set to a number of access per unit time and/or an upper limit value is set to an amount of data communication per unit time.

Here, the unit time means a time of predetermined length, for example as one minute or one hour. Further, the upper limit value of the number of access per unit time is an upper limit value such as 300 times within one hour, and the upper limit value of the amount of data communication per unit time is an upper limit value such as 1 TB within one hour. Note that, the number of access to the online storage 300 corresponds to a number of the NAS 200 calling an API (Application Program Interface) provided in the online storage 300.

In the explanation of the disclosure below, the utilization restriction in which the upper limit value of the number of access per unit time is set will mainly be explained. Note that, by interpreting the “access number” described later to the “amount of data communication”, the utilization restriction in which the upper limit value of the amount of data communication per unit time is set can similarly be applied.

(NAS Configuration)

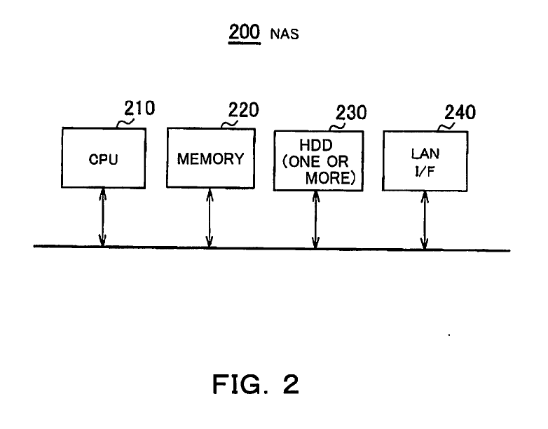

Next, a hardware configuration of the NAS 200 will be explained. FIG. 2 is a hardware configuration diagram of the NAS 200.

As shown in FIG. 2, the NAS 200 includes a CPU (Central Processing Unit) 210, memory 220, one or more HDD (Hard Disk Drive) 230, and the LAN I/F 240. The CPU 210, the memory 220, the HDD 230 and the LAN I/F 240 are connected to one another through a bus line.

The CPU 210 controls the respective functions of the NAS 200 by executing a control program (firmware) stored in the memory 220.

The memory 220 includes flash memory and RAM (Random Access Memory). The flash memory stores the control program to be executed by the CPU 210. The RAM temporarily stores the control program read from the flash memory and is used as a work area of the CPU 210.

The memory 220 may include a cache area for caching files to be uploaded to the online storage 300 and files downloaded from the online storage 300. Further, the memory 220 stores contents of the utilization restriction (which is in the present disclosure the upper limit value of the number of access per unit time or the like) for the online storage 300.

The HDD 230 stores the respective files. The HDD 230 may be configured as a disk array, and may configure RAID (Redundant Arrays of Inexpensive Disks).

The LAN I/F 240 is connected to the LAN 10, and is configured to communicate through the LAN 10. The LAN I/F 240 may be wiredly connected to the LAN 10, and may be wirelessly connected to the LAN 10. The LAN I/F 240 receives a file storing request, a storage target file, a file updating request, a file reading request and the like from the PC 100.

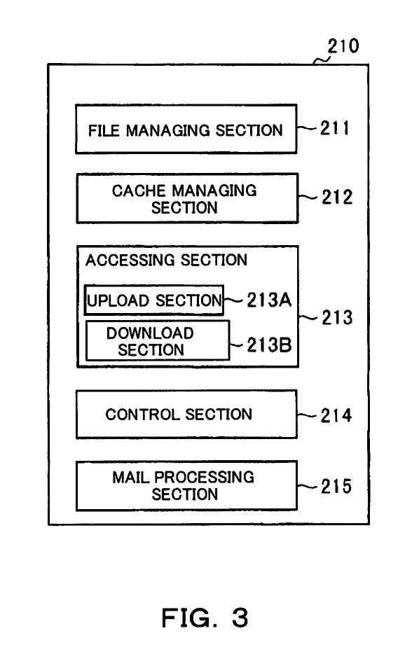

Next, a software configuration of the NAS 200 will be explained. FIG. 3 is a software configuration diagram of the NAS 200.

As shown in FIG. 3, the CPU 210 configures the respective function sections of the file managing section 211, a cache managing section 212, an access section 213, the control section 214, and the mail processing section 215 by executing the control program stored by the memory 220.

The file managing section 211 corresponds to a file system. In the present disclosure, the file managing section 211 performs file management by the directory configuration in which a virtual local directory indicating the online storage 300 is arranged as a lower directory of a directory indicating the NAS 200. By accessing the NAS 200, the PC 100 can browse through the directory configuration and perform file operation to the aforementioned directory configuration. Specific example of the aforementioned directory configuration will be explained later.

The cache managing section 212 caches the file (storage target file) to be uploaded to the online storage 300 and the file downloaded from the online storage 300 to the cache area provided in the memory 220. Further, the cache managing section 212 updates the cached file in accordance with the file updating request from the PC 100.

In the present disclosure, when the file storing request to the virtual local directory is made, the cache managing section 212 caches the storage target file corresponding to the file storing request to the cache area. Further, when the file updating request to the cached file is made, the cache managing section 212 updates the aforementioned file. These file storing request and file updating request are sent through the LAN 10 and the like for example from the user terminal such as the PC 100.

The access section 213 corresponds to the API provided corresponding to the online storage 300. The access section 213 performs at least one of access processes of the upload to the online storage 300 and the download from the online storage 300. The access section 213 includes an upload section 213A performing the upload to the online storage 300 and a download section 213B performing the download from the online storage 300. Note that, information necessary for the access process by the access section 213 to the online storage 300 is assumed as being predeterminedly stored in the memory 220.

The upload section 213A uploads the file cached by the cache managing section 212 to the online storage 300 under the control by the control section 214. Further, the download section 213B downloads the file corresponding to the file reading request from the online storage 300 under the control by the control section 214.

The control section 214 monitors the number of access (that is, the number of calling the API) per unit time by the access section 213, and performs the access inhibiting control for inhibiting the access process by the access section 213 based on the number of access per unit time so that the utilization restriction stored in the memory 220 is satisfied. The control section 214 performs the access inhibiting control if the number of access per unit time by the access section 213 exceeds the access number threshold. Note that, the aforementioned number of access per unit time is set to be less than the upper limit value of the number of access per unit time as the utilization restriction, and is assumed as being predeterminedly stored in the memory 220.

As the access inhibiting control, the control section 214 performs a process to withhold uploading the file until a predetermined withholding time (timeout time) since the file has been cached by the cache managing section 212 elapses, even if the file is updated. The control section 214 extends the time to withhold uploading the file as the update of the cached file is more frequent. Further, as the access inhibiting control, the control section 214 performs control to withhold download from the online storage 300 and retry the download after the predetermined time has elapsed.

If the upload to the online storage 300 by the upload section 213A fails, the mail processing section 215 sends an e-mail reporting the failure of the upload to the PC 100. Note that, the mail processing section 215 can detect the upload failure to the online storage 300 based on an exit code sent from the online storage 300 in connection to the upload. Further, an e-mail address of the PC 100 is assumed as being predeterminedly stored in the memory 220.

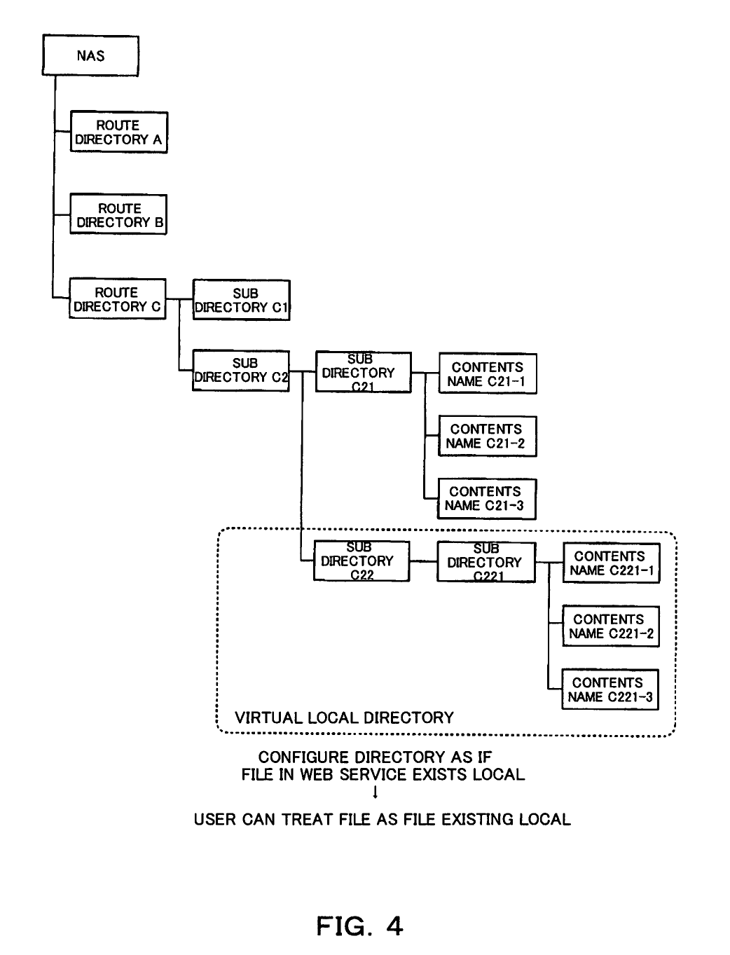

Next, a specific example of the directory configuration managed by the file managing section 211 will be explained. FIG. 4 is a diagram showing the specific example of the directory configuration that the file managing section 211 manages.

As shown in FIG. 4, the aforementioned directory configuration includes route directories A to C indicating the NAS 200, includes sub directories C1 and C2 as lower directories of the route directory C, and includes sub directories C21 and C22 as lower directories of the sub directory C2.

An entity of each file (contents C21-1 to C21-3) included in the sub directory C21 is stored in the NAS 200. Contrary to this, an entity of each file (contents C221-1 to C221-3) included in (the sub directory C221 of) the sub directory C22 is stored in the online storage 300.

Accordingly, although the directories under the sub directory C22 are dealt as if the files exist in the NAS 200, the entities of the aforementioned files exist in the online storage 300, and thus are configured as virtual local directories.

Note that, such virtual local directory can be configured for example by using a FUSE (Filesystem in Userspace) that is one of software capable of constituting a file system.

(Operation of NAS)

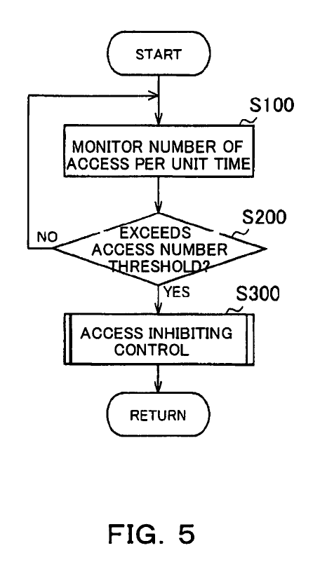

Next, an operation of the NAS 200 will be explained. FIG. 5 is an operational flow chart of the NAS 200.

As shown in FIG. 5, in step S 100, the control section 214 monitors (counts) the number of access (that is, the number of calling the API) per unit time by the access section 213.

In step S200, the control section 214 determines whether the number of access per unit time by the access section 213 exceeds the access number threshold or not. Note that, since the access number threshold is a value smaller than the upper limit value of the number of access per unit time as the utilization restriction, the number of access per unit time by the access section 213 exceeding the access number threshold means that the number of access per unit time by the access section 213 is coming close to the upper limit value.

If the number of access per unit time by the access section 213 does not exceed the access number threshold (step S200: NO), the control section 214 returns the process to step S100. Contrary to this, if the number of access per unit time by the access section 213 exceeds the access number threshold (step S200: YES), the control section 214 proceeds the process to step S300.

Here, in the case where the number of access per unit time by the access section 213 does not exceed the access number threshold, it means that the number of access per unit time by the access section 213 has more to spare with respect to the upper limit value; thus, the upload may frequently be performed so as to synchronize the file to be cached and the file stored in the online storage 300, and the download may immediately he performed in response to the file reading request.

In step S300, the control section 214 performs the access inhibiting control. Hereinbelow, details of step S300 will be explained.

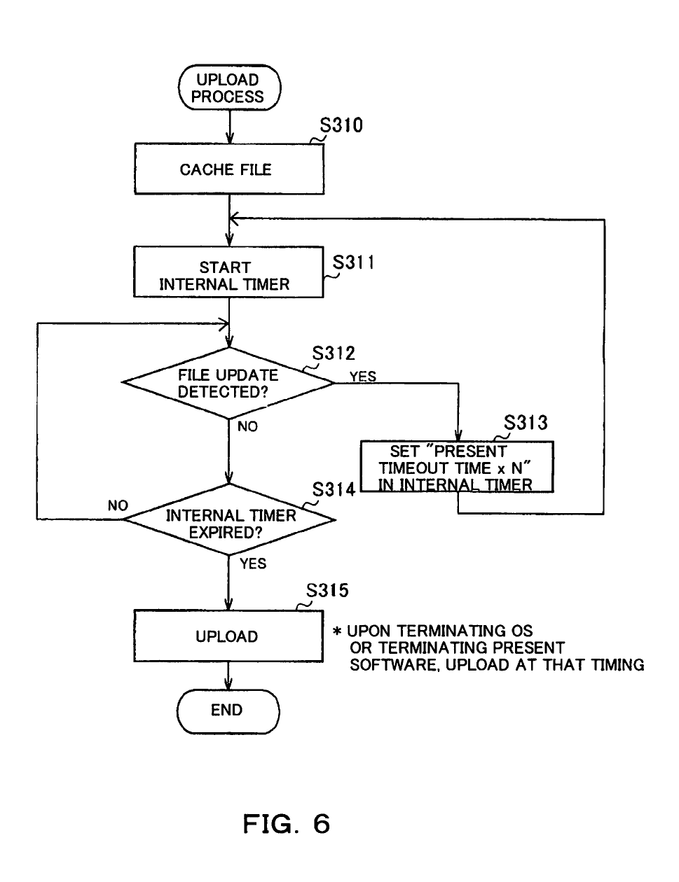

The upload process in step S300 of FIG. 5 will be explained. FIG. 6 is a flow chart of the upload process in step S300 of FIG. 5. Here, the upload process for the virtual local directory will be explained.

As shown in FIG. 6, in step S310, the cache managing section 212 caches the storage target file and stores the same in the cache area in response to the file storing request to the virtual local directory.

In step S311, the control section 214 sets an initial value (for example, 15 seconds) for a timeout time to an internal timer, and activates the internal timer.

In step S312, the control section 214 confirms whether a file updating request has been made to the file cached by the cache managing section 212. If the file updating request has been made to the file cached by the cache managing section 212 (step S312: YES), the control section 214 proceeds the process to step S313. Contrary to this, if the file updating request has not been made to the file cached by the cache managing section 212 (step S312: NO), the control section 214 proceeds the process to step S314.

In step S313, the control section 214 resets the internal timer by extending the present timeout time by N times (for example, two times), and thereafter returns the process to step S311. In step S311, the internal timer with the timeout time that had been extended by N times is activated.

On the other hand, in step S314, the control section 214 determines whether the internal timer has expired or not (has been timeout or not). If the internal timer has expired (step S314: YES), the control section 214 proceeds the process to step S315. Contrary to this, if the internal timer has not expired (step S314: NO), the control section 214 returns the process to step S312. In step S312, the presence/absence of the file updating request is again determined.

In step S315, the control section 214 controls the upload section 213A to upload the file cached by the cache managing section 212.

As above, in the example of this flow, the upload of the file is withheld at least 15 seconds (predetermined withholding time), and if a file update of the aforementioned file is detected during such period, the upload of the aforementioned file is further withheld for 30 seconds. Further, if the file update of the aforementioned file is detected during 30 seconds of withholding, the upload of the aforementioned file is further withheld for 60 seconds. Accordingly, the upload withholding time can be extended for the file with higher update frequency.

Note that, in the aforementioned control also, if the upload has failed, an upload failure notification is made by the mail processing section 215 using an e-mail.

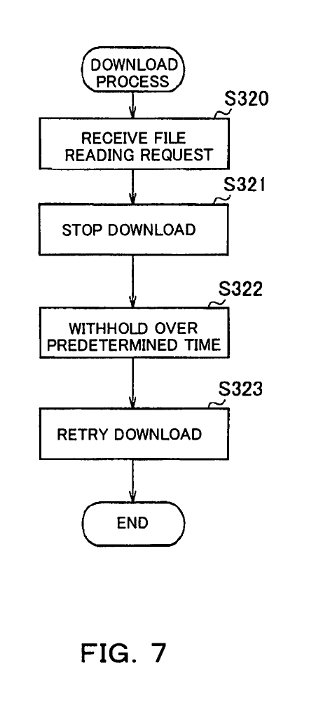

Next, the download process in step S300 of FIG. 5 will be explained. FIG. 7 is a flow chart of the download process in step S300 of FIG. 5. Here, the download process for the virtual local directory will be explained.

As shown in FIG. 7, in step S320, the file managing section 211 receives the file reading request to the virtual local directory from the PC 100.

In step S321, the control section 214 controls so that the download of the read target file corresponding to the file reading request received by the file managing section 211 is stopped.

In step S322, the control section 214 once stops the download of the read target file, and waits for the predeterminedly set withholding time to elapse.

In step S323, when the withholding time has elapsed, the control section 214 controls the download section 213B to download the read target file.

(Effects)

As explained above, the NAS 200 of the present disclosure can appropriately perform storing and reading files even if the utilization restriction is set to the online storage 300 by the service provider. Further, by performing the access inhibiting control to withhold the upload until the predetermined withholding time elapses since the file has been cached instead of immediately performing the upload each time the file is updated, the NAS 200 can prevent the increase in the traffic load for uploading even in the case of dealing the frequently updated file.

In the present disclosure, the NAS 200 performs the access inhibiting control if the number of access per unit time by the access section 213 exceeds the access number threshold, which is set to be less than the upper limit value as the utilization restriction. Due to this, since the access inhibiting control can be performed at a state before the number of access per unit time by the access section 213 exceeds the upper limit value as the utilization restriction, the problem that the storing and reading of the file become impossible due to the access to the online storage 300 becoming unavailable can be solved.

In the present disclosure, the NAS 200 extends the time to withhold uploading the file as the update of the cached file is more frequent. Due to this, since the upload withholding time for the frequently updated file can be extended (made longer), the frequency of the upload can effectively be reduced, and the frequently updated file can be uploaded at an appropriate timing.

Further, in the present disclosure, as the access inhibiting control, the NAS 200 performs control to withhold download from the online storage 300 and retry the download after the predetermined time has elapsed; thereby the download can be performed while satisfying the utilization restriction of the online storage 300.

In the present disclosure, if the upload to the online storage 300 fails, the NAS 200 sends an e-mail reporting the failure of the upload to the PC 100; thereby, the failure of the upload can be notified to the user. Especially, in performing the control to withhold the upload as mentioned above, a delay occurs during a time from when the user performed the file storing operation to when the upload is executed. In such circumstance the user will unlikely notice that the upload has failed, so the failure notification by the e-mail is effective.

In the present disclosure, the NAS 200 performs the file management by the directory configuration in which the virtual local directory indicating the online storage 300 is arranged as the lower directory of the directory indicating the NAS 200. Due to this, the online storage 300 can be dealt similar to the local storage by changing the directory configuration.

In the present disclosure, the NAS 200 uploads the file to the online storage 300 based on the storing or updating request of the file to the virtual local directory. Due to this, the file that is stored or updated to the virtual local directory can automatically be uploaded to the online storage 300.

(Modifications)

Further, it should be understood that statements and drawings do not restrict this disclosure. From this disclosure, various alternative embodiments, examples and application techniques will be obvious to those skilled in the art.

For example, although the NAS 200 was used as the file managing apparatus, the PC 100 may be used as the file managing apparatus instead of the NAS 200. In this case, the PC 100 includes similar configurations as the hardware configuration shown in FIG. 2 and the software configuration shown in FIG. 3, and performs the respective flows shown in FIG. 5 to FIG. 7.

Accordingly, it should be understood that the present invention covers various embodiments and the like that are not described herein.

What is claimed is:

1. A file managing apparatus configured comprising:
a processor that:
caches a file to be uploaded to an online storage; and
controls withholding uploading the file to the online storage until a predetermined withholding time elapses since the file has been cached, even if the file is updated.

2. The file managing apparatus according to claim 1, wherein
the processor extends the time to withhold uploading the file as updates of the cached file increase in frequency.

3. The file managing apparatus according to claim 1, further comprising:
a communication interface that receives the file transmitted from a user terminal via a network, wherein
the processor caches the file transmitted from the user terminal via the network.

4. The file managing apparatus according to claim 3, wherein
the processor controls the communication interface to send, if the upload to the online storage fails, an e-mail reporting the failure of the upload to the user terminal.

5. The file managing apparatus according to claim 1, wherein
the processor performs file management by a directory configuration in which a virtual local directory indicating the online storage is arranged as a lower directory of a directory indicating the file managing apparatus.

6. The file managing apparatus according to claim 5, wherein
the processor caches the file based on a file storing request to the virtual local directory.

7. A non-transitory computer readable storage medium including a program, which when executed by a computer, causes the computer to perform a process of managing access to an online storage, the process comprising:
caching a file to be uploaded to an online storage; and
withholding uploading the file until a predetermined withholding time elapses since the file has been cached, even if the file is updated.

8. The non-transitory computer readable storage medium according to claim 7, wherein
the withholding includes extending the time to withhold uploading the file as updates of the cached file increase in frequency.

9. The non-transitory computer readable storage medium according to claim 7, the process further comprising:
receiving the cached file from a user terminal via a network.

10. The non-transitory computer readable storage medium according to claim 9, the process further comprising:
sending, if the upload to the online storage fails, an e-mail reporting the failure of the upload to the user terminal.

11. The non-transitory computer readable storage medium according to claim 7, the process further comprising:
performing file management by a directory configuration in which a virtual local directory indicating the online storage is arranged as a lower directory of a directory indicating the computer.

12. The non-transitory computer readable storage medium according to claim 11, wherein
the caching includes caching the file based on a file storing request to the virtual local directory.

13. A method of managing access to an online storage performed by a computer, the method comprising:
caching, by a processor of the computer, a file to be uploaded to the online storage; and
withholding, by the processor, uploading the file until a predetermined withholding time elapses since the file has been cached, even if the file is updated.
